(19) United States
(12) Patent Application Publication
(10) Pub. No.: US 2003/0049359 A1
(43) Pub. Date: Mar. 13, 2003

(54) Self-rising sheeted dough

(76) Inventors: Rajendra G. Kulkarni, East Amherst, NY (US); Cheryl A. Smith, Lockport, NY (US)

Correspondence Address: KENYON & KENYON, 1500 K STREET, N.W., SUITE 700, WASHINGTON, DC, 20005, US

(21) Appl. No.: 09/946,548

(22) Filed: Sep. 6, 2001

(51) Int. Cl. A21D 2/00

(52) U.S. Cl. 426/551

(57) ABSTRACT

Frozen sheeted dough including flour, water, a chemical leavening agent having a soda ingredient present in an amount of about 0.5% to about 2% by weight (as compared to the amount of flour) and an acid ingredient, and from about 3% to about 9% by weight of yeast, where the frozen sheeted dough does not require proofing. Preferably, the dough is shaped into the form of a pizza or breadsticks. The dough may contain additional ingredients. The dough may be topped with one or more toppings. Also provided is a method of making frozen sheeted dough that includes combining the ingredients, and shaping and freezing the dough, where the dough does not require proofing. Further provided are methods of making pizza or breadsticks, which do not require proofing the dough.

### FIELD OF THE INVENTION

The present invention relates to frozen sheeted dough that does not require proofing. The present invention also relates to a method of making frozen sheeted dough that includes combining the ingredients, shaping and freezing the dough, but does not include proofing the dough.

Further provided is a method of making pizza or breadsticks that includes removing frozen sheeted dough of the present invention from a freezer and without proofing or thawing the dough, transferring the dough to an oven that is pre-heated to a temperature sufficient to bake the pizza or breadsticks.

### BACKGROUND OF THE INVENTION

Commercially available frozen dough products, including sheeted dough, such as pizza dough, must be “proofed” prior to baking. “Proofing” is the time required for yeast in a dough to produce sufficient amount of carbon dioxide gas to give correct height, volume, and structure in a baked product. Generally, an end user (e.g., the consumer or retailer) of a frozen dough product is inconvenienced by the need to thaw and proof the product prior to baking. The time required for thawing and proofing may be as much as 2-4 hours depending on the product. Additionally, the proofing step requires additional space, equipment (such as retarders or proofers), and labor, either on the consumer end or in the manufacturing end in making the dough.

Proofing may be carried out (at least to some extent) by a manufacturer of frozen dough products, prior to freezing, so as to minimize or eliminate the need for proofing by the end user, thus, minimizing consumer preparation time from freezer to point of consumption. See, for example, U.S. Pat. Nos. 4,847,104 and 4,966,778 to Benjamin et al. The resultant dough is termed “pre-proofed” frozen dough. A serious drawback of these processes is that they call for special expensive ingredients, e.g., flour containing more than 16% protein. These processes are also disadvantageous in that they shift the burden of proofing from the end user to the manufacturer, increasing production time and cost and, ultimately, increasing cost to consumer.

Use of chemical leavening agents in place of yeast obviates the need for proofing, but it detracts from the texture, flavor, and structure associated with proofed dough products. An illustrative example is provided by a comparison of a biscuit or Irish soda bread (chemically leavened; unproofed) with a bread loaf, a dinner roll, or a bread stick (yeast leavened; proofed). Proofed products are generally lighter, less dense, less chewy, more porous, more aerated than chemically leavened unproofed products.

Frozen doughs have been described that do not require a proofing step. See U.S. Pat. No. 5,451,417. However, these doughs require so much chemical leavening agent that the resulting dough is biscuit-like in taste and texture.

A frozen sheeted dough is desirable that may be transferred directly from a freezer to an oven without proofing by either the end user prior to baking or by the manufacturer prior to freezing, which when baked is substantially similar to a proofed sheeted product in texture, flavor, structure, and aroma.

### SUMMARY OF THE INVENTION

The present invention provides frozen sheeted dough, preferably pizza or breadstick dough that does not need to be proofed prior to baking. The frozen sheeted dough of the present invention when baked is substantially similar to a proofed sheeted product with regard to its flavor, volume, texture, structure, and aroma.

In particular, the present invention relates to frozen sheeted dough that includes flour, water, a chemical leavening agent including at least one soda ingredient and at least one acid ingredient, where the soda ingredient is present in an amount of from about 0.5% to about 2% of the amount of flour, and from about 3% to about 9% by weight of yeast, where the frozen dough does not require proofing. According to a preferred embodiment of the present invention, the ratio of yeast to the at least one soda ingredient is from about 3:1 to about 5:1, more preferably, about 4:1. The frozen sheeted dough optionally includes one or more additional ingredients, such as flavorings. Preferably, the dough is shaped into the form of a pizza or breadsticks. The dough is optionally topped with one or more toppings or flavorings.

The present invention also provides methods of making frozen pizza or breadstick dough, which do not include proofing. These methods include combining the frozen dough ingredients, which include flour, water, a chemical leavening agent having a soda ingredient in an amount of about 0.5% to about 2% (as compared to the amount of flour), and from about 3% to about 9% by weight of yeast, and shaping and freezing the dough. The frozen dough does not require proofing.

The present invention further provides methods of making pizza or breadsticks from a frozen sheeted dough, in which the method does not require proofing steps. Further provided is a method of making pizza or breadsticks that includes removing frozen pizza or breadstick dough of the present invention from a freezer and without proofing or thawing the dough, transferring the dough to an oven that is pre-heated to a temperature sufficient to bake the pizza or breadsticks.

### DETAILED DESCRIPTION

The present invention will now be described in detail for specific preferred embodiments of the invention, it being understood that these embodiments are intended only as illustrative examples and the invention is not to be limited thereto.

The present invention relates to the field of frozen sheeted dough, and in particular to frozen sheeted dough for making pizzas and breadsticks. The present inventors have discovered that dough having both chemical leavening agents including both a soda and an acid ingredient, where the soda ingredient is present in an amount of about 0.5% to about 2% by weight, and yeast in an amount of about 3% to about 9% by weight, is particularly useful in that it may be manufactured and cooked without proofing and does not have significant disadvantages over the prior art.

The present invention is advantageous over other doughs known in the art in that the dough and methods of the present invention do not require proofing (either before or after freezing the dough) and do not require thawing prior to transferring the dough to an oven, while the dough maintains the desirable properties such as flavor, texture, stability, etc. of known dough. Moreover, the present invention does not require that the dough be transferred to a un-pre-heated oven that is subsequently heated to a temperature sufficient for baking the dough. Further, the dough of the present invention is not biscuit-like in taste or flavor, but rather is similar to conventional pizza doughs and breadsticks in texture and taste. Thus, the dough and methods of the present invention are advantageous in that they do not require the time, processing steps, equipment, space and labor that is required by methods and dough known in the art, and they have an acceptable taste and texture.

Frozen Sheeted Dough

The present invention relates to frozen sheeted dough that does not require proofing. The dough of the invention includes flour, water, a chemical leavening agent, and from about 3% to about 9% by weight of yeast. According to the present invention the chemical leavening agent includes at least one soda ingredient and at least one acid ingredient, where the at least one soda ingredient is present in an amount of from about 0.5% to about 2% by weight.

All weights referred to herein, unless indicated otherwise, are by total weight of flour contained in the raw dough prior to freezing. All ratios are by weight of the ingredients.

The chemical leavening agent of the present invention includes at least one soda ingredient and at least one acid ingredient. The soda ingredient may include one or more soda ingredients known to those skilled in the art, including for example, sodium bicarbonate, potassium bicarbonate, and the like and mixtures thereof. The acid ingredient may include one or more acid ingredients known to those skilled in the art, including for example, sodium aluminum phosphate, sodium acid pyrophosphate, glucono delta lactone, monocalcium phosphate monohydrate, sodium aluminum sulfate, dicalcium phosphate, glucono delta lactone, potassium hydrogen tartrate, calcium pyrophosphate, and the like and mixtures thereof.

The soda ingredient is present in an amount of from about 0.5% to about 2%, preferably about 1.5%. Higher amounts of chemical leavening agent result in the dough having a biscuit-like quality, which is generally undesirable in the sheeted dough of the present invention. The ratio of soda ingredient to acid ingredient depends on the particular leavening acid employed, but in any event the amount of leavening acid is such that the soda ingredient is completely neutralized. Therefore, the acid ingredient is also preferably present in an amount from about 0.5% to about 2%. Thus, the chemical leavening agent (including both the soda and acid ingredients) is preferably present in an amount of about 1% to about 4% by weight of the total amount of flour. More preferably, the chemical leavening agent is present in an amount of about 3% by weight of the total amount of flour. The leavening agent is a slow acting leavening agent, such as for example, sodium aluminum phosphate and the like.

The frozen dough of the present invention includes yeast. It is believed that yeast in the inventive dough does not act as a leavening agent (since the dough does not have to be proofed prior to baking); rather, yeast is added in order to impart to a baked product prepared from the inventive dough, the flavor and aroma of a proofed baked product. This combination of yeast and chemical leavening achieves product quality with regard to taste, flavor and appearance. Traditional frozen dough for preparation of proofed products does not include chemical leavening at levels employed herein; traditional doughs either omit chemical leavening or include very small amounts of chemical leavening.

Yeast included in the inventive dough may be any type of suitable yeast known to those skilled in the art, including for example, yeast cream, compressed yeast, instant dry yeast, active dry yeast, protected active dry yeast, frozen yeast and combinations thereof. Preferred yeast according to the present invention is in the form of yeast cream.

The amount of yeast may be chosen to correspond to a desired flavor profile. Yeast amount also affects useable life of the dough. The yeast is preferably present in an amount of about 4% to about 8% by weight of the total amount of flour. Even more preferably, the yeast is present in an amount of about 6% by weight of the total amount of flour.

The frozen sheeted dough according to the present invention further includes at least flour and water in effective amounts to prepare the dough.

The flour of the present invention may include one or more types of flour. Preferably, the flour includes at least 50% high gluten flour and 100% of the flour is Enriched Flour, i.e., flour that contains federally mandated amounts of flour, niacin, ferrous sulfate, riboflavin, enzyme, and thiamine mononitrate. The term “high gluten” as used herein means long patent flour made from high protein (i.e., greater than 10% protein). The flour of the present invention preferably has from about 10% to about 14% by weight protein, more preferably about 11% to about 13% by weight protein. High-protein flours are preferred because they provide the dough product with greater protein structure and/or quantity. Increased protein structure and/or quantity binds up water better within the dough product, maintaining and holding moisture within the product to yield longer shelf life. Additionally, enhanced protein characteristics provide better elasticity and expandability, which aid in holding gases generated due to yeast action and thus promote the raising of the dough.

Non-limiting examples of flours that may be included in the flour of the present invention include for example, Enriched Flour, bread flour, wheat flour, barley flour, rye flour bread, corn flour, potato flour and pastry flour. Bread flour has high absorption and good mixing tolerance.

The precise amount of water depends on the type of yeast included. Typically, from 40% to 75% of water is employed, preferably from 45% to 65%. Using less than 40% of water may result in poor processing (tearing/breaking) and/or in a dry baked product. Using more than 75% of water may result in excessively sticky dough and a gummy baked product.

The frozen dough of the present invention optionally contains one or more additional ingredients including for example, iron (preferably in the form of ferrous sulfate), glutathione, calcium sulfate, salt, stabilizer(s), ascorbic acid, flavored oils, an enzyme, sugar, niacin, at least one fat source, riboflavin, oil, L-cysteine, ammonium sulfate, corn meal, thiamine mononitrate, flavoring(s), and the like.

A non-limiting example of a stabilizer according to the present invention is a diacetyl tartaric acid ester of monoglyceride.

Enzymes according to the present invention may include for example amylases, in particular fungal amylase. Use of enzymes, such as amylases may be advantageous in that they may retard staling of the frozen dough or resulting pizza or breadsticks. Enzymes may also result in an increased strength, improved extensibility or elasticity, stability and reduced stickiness of the dough, thus resulting in improved machinability during manufacture. The effect on the dough may be particularly advantageous when a poor quality flour is used. The improved machinability is of particular importance in connection with dough which is to be processed industrially. The amount and type of enzyme of the present invention may be determined by those skilled in the art depending on the specific desired resulting properties.

The sugar within the dough acts as a tenderizing agent, promotes desirable flavor, aids with proper browning, and provides a ready “food” supply for the yeast to feed on before feeding on the starches and protein structure.

A fine granulated sugar is preferred for use with embodiments of the invention formed from a pre-mix. Fine granulated sugars promote better mixing and consistency within the pre-mix. Fine granulated sugar, which is not as fine as powdered sugar but not as coarse as table sugar, is readily commercially available, as for example from the Domino Sugar Company.

A fine-blending salt is preferred to promote better mixing, for the same reasons that fine sugar is preferred. Salt may be added for desired flavoring; its hydrophilic properties are believed to help to control moisture content within the dough; and it also aids in controlling yeast activity. Fine-blending salt is readily available on the market, as for example from Cargill, Incorporated.

The dough of the invention preferably includes an effective amount of a fat source. The fat source contributes flavor and texture to the baked goods and may be solid or plastic as well as liquid or semi-fluid.

One example of a suitable fat source according to the present invention includes shortening. Shortening may be any oil or higher melting fat which is suitable for use in baked products. Glyceride shortenings derived from animal or vegetable fats and oils including synthetically prepared shortenings are suitable for use herein. The glyceride may contain saturated or unsaturated long chain acyl radicals having from about 12 to about 22 carbon atoms generally obtained from edible oils and fats such as corn oil, cottonseed oil, soybean oil, coconut oil, rapeseed oil, peanut oil, olive oil, palm oil, palm kernel oil, sunflower seed oil, wall flower oil, lard, tallow and the like. Examples of preferred shortenings according to the present invention, include vegetable shortenings, soybean based shortenings or oils, hydrogenated soybean-based shortening or oil, corn oil, palm oil, hydrogenated palm oil, lard and tallow oils. Butter and/or margarine may also be suitable as a shortening.

Hydrogenated shortening is preferably used to provide a slight crispiness to the outside of the cooked dough. The hydrogenated shortening provides better crust definition and crispiness. Hydrogenated shortening suitable for use with the invention is readily available on the market, as for example the SHO-2 product from Central Soya. Vegetable shortening that may be used in accordance with the present invention is preferably in the form of shortening flakes.

The amount and type of fat source may be selected by those skilled in the art based on various factors including the ingredients of the frozen dough and/or toppings, and based on the desired taste and physical characteristics, such as maintaining a consistent internal structure.

Any oil can be used, according to embodiments of the invention, but vegetable oil is preferred due to concerns about potential off flavors. Vegetable oil lubricates the product to enhance its workability, and it promotes product tenderness. Vegetable oils that may be used in accordance with the present invention, include, but are not limited to soybean oil, cottonseed oil, peanut oil, canola oil, corn oil, olive oil and sunflower oil. Soybean and/or cottonseed oils are preferred. Certain oils, including sunflower and corn oils, potentially adversely affect the overall flavor profile of the dough and are therefore, less preferred.

Flavored oils may also be used in addition to or in place of the oil of the present invention. Non-limiting examples of flavored oils include olive, sesame, ginger and the like.

Flavorings according to the present invention may include, for example, oregano, basil, garlic, pepper, honey, sesame, cheese, cinnamon, wheat oats, peppers, onions, salsa based flavors, and tomatoes. Additionally, to achieve a desired flavor profile, a spray-dried encapsulated flavoring agent may be added to the dough. Spray-dried encapsulated flavorings are readily available on the market. Many different flavors can be used to achieve a desired effect, for example, yeast flavors.

When using flavorings, the amount of water and salt used in the dough may have to be adjusted to take into account, for example, the amount of salt and water already contained in the flavoring. It is believed that “fine tuning” of the amount of salt and water would be within the ability of one of ordinary skill in the art.

When the frozen sheeted dough of the present invention is to be stored frozen for a substantial period of time, it is preferably wrapped in a moisture barrier. The wrapping may occur either before or after being frozen, preferably after freezing.

Preferably, the dough is shaped into a desired shape prior to being frozen, such as, into the form of a pizza or breadsticks. In forming the dough into the shape of a pizza, the dough is preferably sheeted and then cut into a desired shape, such as essentially round or square. When the dough is shaped into the form of breadsticks, the dough is preferably sheeted and perforated prior to being frozen.

The frozen sheeted dough of the present invention is optionally topped with at least one topping. The term “topped” does not necessarily mean that the dough is entirely covered, but it means that a topping is added over at least a portion of the dough, as would be apparent to those in the art.

According to a preferred embodiment, the dough is sheeted and then topped with at least one topping prior to being frozen. Alternatively, the frozen dough is untopped, and after the frozen dough is removed from a freezer, the frozen dough is topped. Also included within the present invention is frozen sheeted dough that is topped over a layer of dough and then another layer of dough is over the topping, such as in the case of pizza pockets, stuffed pizzas, calzones, and the like.

Non-limiting examples of suitable toppings according to the present invention, include sauces, cheeses, vegetables, flavorings, meats and mixtures thereof. Specific examples of toppings according to the present invention include tomato sauce, pesto, mozzarella cheese, pepperoni, sausage, ham, olives, mushrooms, peppers, pineapple, onions, tomatoes, salt, and the like as would be apparent to those skilled in the art.

According to a preferred embodiment, the dough is topped with at least one flavoring. Non-limiting examples of flavorings that may be used as pizza toppings, include for example, oregano, basil, garlic, pepper, honey, sesame, cheese, cinnamon, wheat oats, peppers, onions, salsa based flavors, tomatoes, and the like.

Preferably, the frozen sheeted dough of the present invention includes the following ingredients:

| | |
|---|---|
| flour | |
| water | about 45% to about 70% |
| chemical leavening agent | about 1% to about 4% |
| | (about 0.5% to about 2% soda ingredient) |
| yeast | about 3% to about 9% |
| salt | about 1% to about 3% |
| stabilizer | about 0.2% to about 0.5% |
| sugar | about 3% to about 9% |
| vegetable shortening | about 1% to about 3% |

The frozen dough of this embodiment may include additional ingredients, such as iron, glutathione, calcium sulfate, ascorbic acid, flavored oils, an enzyme, niacin, riboflavin, oil, L-cysteine, ammonium sulfate, corn meal, thiamine mononitrate, at least one flavoring, and the like.

An even more preferred embodiment of the present invention is a frozen sheeted dough that includes the following ingredients:

| | |
|---|---|
| high gluten flour/ | |
| Enriched Flour | |
| water | about 58% |
| baking soda | about 1.5% |
| sodium aluminum phosphate | about 1.5% |
| yeast cream | about 6% |
| salt | about 2% |
| stabilizer | about 0.33% |
| sugar | about 6% |
| vegetable shortening | about 2% |
| ammonium sulfate | about 0.04% |
| ascorbic acid | about 0.036% |
| calcium sulfate | about 0.04% |

The frozen dough of this embodiment may include additional ingredients, such as glutathione, oil, L-cysteine, corn meal, at least one flavoring and the like.

The frozen dough of the above embodiments do not require proofing.

Method of Making Frozen Dough

The present invention also relates to a method of making frozen sheeted dough that includes combining the dough ingredients set forth herein, shaping and freezing the dough. These methods do not include proofing and the dough formed from these methods do not require proofing.

The type and relative amount of ingredients (including the required, preferred and optional ingredients) according to these methods are as set forth above with respect to the frozen sheeted dough of the present invention. In particular, according to the present invention, the ingredients include at least flour, water, chemical leavening agent including at least one soda ingredient and at least one acid ingredient, where the at least one soda ingredient is present in an amount of about 0.5% to about 2%, and yeast in an amount of about 3% to about 9% by weight of the total amount of flour. According to these embodiments, the ratio of yeast to the at least one soda ingredient is preferably from about 3:1 to about 5:1, more preferably about 4:1. Other preferred and optional ingredients and relative amounts of each ingredient according to the present methods are as set forth above with respect to the frozen dough.

The combining step may include either combining all of the ingredients at once or combining different combinations of ingredients first and then combining all of the ingredients together. For example, according to one embodiment, certain of the ingredients are combined to form a pre-mix, including for example, the chemical leavening agent, and optional salt, stabilizers and sugar. Then, the pre-mix is combined with the remaining ingredients including the flour, yeast, water and optional fat source. The pre-mix and/or the final mixture may include one or more additional ingredients as set forth herein.

According to a preferred embodiment of the present invention, the combining step includes forming a pre-mix of the chemical leavening agent, salt, stabilizer and sugar, and then the pre-mix is combined and mixed with flour, vegetable shortening, yeast cream and water. Even more preferably, the combining includes forming a pre-mix of salt, sodium aluminum phosphate, baking soda, ammonium sulfate, ascorbic acid, stabilizer, calcium sulfate, enriched flour, sugar, flour, niacin, ferrous sulfate, riboflavin, enzyme, and thiamine mononitrate, and then combining the pre-mix with high gluten flour, vegetable shortening, yeast cream and water.

Throughout the process of combining ingredients, ingredients may be mixed with one another by mixing methods generally known in the art.

In order to improve the aroma and flavor of the sheeted dough even further, according to an embodiment of the invention, yeast may be hydrated with warm water, allowed to ferment for about 10 minutes, and the resultant mixture is then added to the rest of the ingredients.

After combining the ingredients, they are then mixed (or further mixed if mixing steps have already taken place) by any suitable mixing apparatus, such as a Hobart mixer for example. The ingredients are mixed for about 2 to about 4 minutes on a first speed (low) and then for about 5 to about 7 minutes on a second speed (high), which is faster than the first speed. Preferably, the ingredients are mixed for about 3 minutes on low speed and for about 6 minutes on high speed. Mixing preferably takes place at a temperature of about 58° to about 64° F.

Next, the dough is formed into a desired shape. Shaping preferably includes sheeting the dough and then cutting the dough into the form of a pizza or into the form of breadsticks. For example, shaping optionally includes cutting the dough with a cutter, preferably a rotary cutter or with splitter wheels. Shaping may include perforating the dough.

An embodiment of the present invention includes shaping dough into the form of breadsticks, by sheeting the dough and cutting the dough with 8″ rotary cutter and splitter wheels set at ½″ apart. Different sizes or widths of rotary cutter or splitter wheels may be selected depending on the size of breadstick desired. Preferably, dough being shaped into the form of breadsticks is perforated.

The shaped dough is then frozen by methods known in the art. If the dough is going to be frozen for a short period of time, the mode of freezing is not critical. However, for prolonged stability, the dough should be frozen such that core temperatures of less than −1° C. and preferably between about −1° C. and about −25° C. are obtained within 1 to 6 hours and more preferably within about 1½ to about 4 hours of the time that the dough is placed in the freezing apparatus. When freezing the dough, a uniform cooling rate throughout the dough is desirable. The shaped dough is frozen, preferably by using spiral freezer (−34° C. −52° C.). Carbon dioxide optionally may be used for gradual freezing (−18° C. to −12° C.).

For prolonged stability, the frozen dough is preferably stored at a temperature in a range of from about −41° C. to about −12° C., more preferably at a temperature in the range of from about −29° C. to about −11° C. Frozen dough according to the present invention may be stored for extended periods of time, i.e., at least about 16 weeks.

Optionally, the shaped dough is topped with at least one topping and/or flavoring prior to freezing the dough. Non-limiting examples of suitable toppings and flavorings that may be used in accordance with these methods, are as set forth above.

According to a preferred method herein, the process for preparing the sheeted dough of the present invention is as follows:

1) combining salt, chemical leavening agent and sugar into a pre-mix;

2) combining the pre-mix with flour, a fat source, yeast and water;

3) mixing on low for about 2 to about 4 minutes and then mix on high for about 5 to about 7 minutes at a temperature of about 58° to about 64° F.;

4) shaping the dough into the form of a pizza or breadsticks;

5) adding any toppings and/or flavorings; and

6) freezing the dough to a core temperature of less than −1° C.

The frozen sheeted dough made according to the present methods does not need to be thawed or proofed prior to baking. The dough may be taken directly from the freezer to the oven. The resulting baked product preferably substantially resembles a traditional proofed product in appearance, structure, and taste.

The present invention is also directed to frozen sheeted dough made by the methods described herein.

Methods of Making Pizza or Breadsticks

Further provided are methods of making pizza that include removing frozen sheeted dough of the present invention (made by the above-described methods or other methods that would be apparent to those skilled in the art), which is shaped into the form of a pizza, from a freezer and without proofing or thawing the dough, transferring the dough to an oven that is pre-heated to a temperature sufficient to bake the pizza.

Also provided are methods of making breadsticks that includes removing frozen sheeted dough of the present invention (made by the above-described methods or other methods that would be apparent to those skilled in the art), which is shaped into the form of breadsticks, from a freezer and without proofing or thawing the dough, transferring the dough to an oven that is pre-heated to a temperature sufficient to bake the breadsticks.

The oven preferably is a thermostatically-controlled oven. However, any oven known in the art that is suitable for cooking pizza or breadsticks, may be used.

A yeast-leavened baked food is typically considered fully baked when its interior reaches a temperature of at least about 75° C., preferably about 80° C., whereas a chemically leavened baked food is typically considered fully baked when its interior reaches a temperature of at least about 95° C., preferably about 100° C. These interior temperatures are typically achieved by heating the product to a temperature in the range of from about 250° F. to about 500° F., more preferably from about 325° F. to about 450° F., for a corresponding period of time in the range of from about 10 to about 50 minutes, depending on the weight and shape of the baked product, as well as the type of oven used to bake the product. The dough of the present invention, which is both yeast and chemically leavened, would be fully baked when its interior reaches a temperature of about at least about 80° C.

In the methods of the present invention frozen sheeted dough is transferred to an oven without a proofing step. The oven is preferably pre-heated to a temperature sufficient to bake the pizza or breadsticks prior to transferring the dough to the oven. For example, the oven may be pre-heated to a temperature of about 325° F. to about 475° F., preferably about 400° F., which cooks the pizza or breadsticks after about 4 to about 20 minutes. Alternatively, the dough may be transferred to an oven that has not been pre-heated, or as only been partially pre-heated.

The exact conditions under which the dough is baked will depend upon the type of product, and will be apparent to one skilled in the art. For example, shapes having greater surface-to-volume ratios will cook faster than shapes having lesser surface-to-volume ratios.

The methods of the present invention optionally include adding at least one topping over the pizza or breadstick dough either before freezing the dough or after removing the dough from the freezer. Toppings in accordance with this embodiment include one or more of the toppings set forth above.

Further provided by the present invention are pizzas and breadsticks made by the methods described herein. Preferably, the pizzas and breadsticks of the present invention are substantially similar in appearance, texture, structure, flavor, and aroma to pizza and breadsticks, which use a dough that was proofed.

The present invention will now be described in detail with respect to showing how certain specific representative embodiments thereof may be made, apparatus and process steps being understood as examples that are intended to be illustrative only. In particular, the invention is not intended to be limited to the methods, ingredients, conditions, process parameters, apparatus and the like specifically recited herein.

### EXAMPLE 1

Dough is prepared from the following ingredients:

| INGREDIENTS | PERCENT BY WEIGHT |
|---|---|
| high gluten flour/ | |
| Enriched Flour | |
| water | 58% |
| baking soda | 1.5% |
| sodium aluminum phosphate | 1.5% |
| yeast* | 6% |
| salt | 2% |
| stabilizer | 0.33% |
| sugar | 6% |
| vegetable shortening | 2% |
| ammonium sulfate | 0.04% |
| ascorbic acid | 0.036% |
| calcium sulfate | 0.04% |

*Yeast Cream

All ingredients are mixed together using a Hobart mixer, with a paddle on low speed for about three minutes and on high speed for about six minutes.

The dough is sheeted and cut into the form of round pizza dough. The dough is frozen directly after mixing (no proofing step). After frozen storage, the pizza dough is topped with tomato sauce, cheese, and flavorings including oregano, basil and garlic and baked without thawing or proofing, at about 400° F. for 15-25 minutes.

### EXAMPLE 2

All ingredients, except flour, shortening flakes, yeast cream and water, are combined with each other to form a pre-mix. The premix is then combined with the flour, shortening, yeast, and water and all of the ingredients are mixed as set forth in Example 1.

The dough is then shaped, frozen and subsequently baked as in Example 1.

### EXAMPLE 3

The ingredients from Example 1 are combined and mixed as set forth therein. The mixture is then sheeted and shaped into the form of pizza and topped with tomato sauce, cheese, pepperoni and various flavorings including oregano, basil and garlic. Without proofing, the dough is frozen. After frozen storage, the pizza is baked without thawing or proofing, at about 400° F. for 15-25 minutes.

### EXAMPLE 4

The ingredients from Example 1 are combined and mixed as set forth therein. The mixture is then shaped into the form of breadsticks, perforated and frozen.

The frozen breadstick dough is then baked without thawing or proofing, at 400° F. for 1 about 5-25 minutes.

While the present invention is described with respect to particular examples and preferred embodiments, it is understood that the present invention is not limited to these examples and embodiments. In particular, the present invention is not limited to the ingredients or toppings listed herein so long as the dough has both a chemical leavening agent and yeast. Moreover, the present invention is not limited to the processing steps recited herein and may contain additional steps, such as mixing steps, as would be apparent to those skilled in the art depending on what ingredients are used.

The present invention as claimed therefore, includes variations from the particular examples and preferred embodiments described herein, as will be apparent to one of skill in the art.

We claim:

1. Frozen sheeted dough, comprising
flour; water; a chemical leavening agent including at least one soda ingredient and at least one acid ingredient, where the at least one soda ingredient is present in an amount of about 0.5% to about 2% by weight of the total amount of flour; and yeast in an amount of about 3% to about 9% by weight of the total amount of flour;
wherein the frozen dough does not require proofing.

2. The frozen sheeted dough of claim 1, wherein the yeast is present in an amount of about 4% to about 8% by weight of the total amount of flour.

3. The frozen sheeted dough of claim 1, wherein the yeast is present in an amount of about 6% by weight of the total amount of flour.

4. The frozen sheeted dough of claim 1, wherein the yeast is in the form of yeast cream.

5. The frozen sheeted dough of claim 1, wherein the at least one soda ingredient of the chemical leavening agent is selected from the group consisting of sodium bicarbonate and potassium bicarbonate, and the at least one acid ingredient is selected from the group consisting of sodium aluminum phosphate, sodium acid pyrophosphate, and glucono delta lactone.

6. The frozen sheeted dough of claim 1, wherein the leavening agent is a slow acting leavening agent.

7. The frozen sheeted dough of claim 1, wherein the soda ingredient is present in an amount of about 1.5% by weight of the total amount of flour.

8. The frozen sheeted dough of claim 1, wherein the flour is high gluten flour.

9. The frozen sheeted dough of claim 1, wherein the flour has preferably from about 10% to about 14% by weight protein.

10. The frozen sheeted dough of claim 1, further comprising at least one ingredient selected from the group consisting of iron, glutathione, calcium sulfate, salt, at least one stabilizer, ascorbic acid, flavored oils, an enzyme, sugar, niacin, at least one fat source, riboflavin, oil, L-cysteine, ammonium sulfate, corn meal, thiamine mononitrate, and at least one flavoring.

11. The frozen sheeted dough of claim 10, wherein the at least one stabilizer is a diacetyl tartaric acid ester of monoglyceride.

12. The frozen sheeted dough of claim 10, wherein the at least one fat source comprises vegetable shortening.

13. The frozen sheeted dough of claim 10, wherein the at least one flavoring is selected from the group consisting of oregano, basil, garlic, pepper, honey, sesame, cheese, cinnamon, wheat oats, peppers, onions, salsa based flavors, and tomatoes.

14. The frozen sheeted dough of claim 1, wherein the dough is shaped into the form of a pizza.

15. The frozen sheeted dough of claim 1, wherein the dough is shaped into the form of breadsticks.

16. The frozen sheeted dough of claim 1, wherein the dough is topped with at least one topping.

17. The frozen sheeted dough of claim 16, wherein the at least one topping is selected from the group consisting of tomato sauce, pesto, cheese, pepperoni, sausage, ham, olives, mushrooms, peppers, pineapple, onions, tomatoes, and salt.

18. The frozen sheeted dough of claim 1, wherein the dough is topped with at least one flavoring.

19. The frozen sheeted dough of claim 18, wherein the at least one flavoring is selected from the group consisting of oregano, basil, garlic, pepper, honey, sesame, cheese, cinnamon, wheat oats, peppers, onions, salsa based flavors, and tomato.

20. The frozen sheeted dough of claim 1, wherein the ratio by weight of yeast to the at least one soda ingredient is from about 3:1 to about 5:1.

21. The frozen sheeted dough of claim 1, wherein the ratio by weight of yeast to the at least one soda ingredient is about 4:1.

22. The frozen sheeted dough of claim 1, wherein the dough is perforated prior to being frozen.

23. Frozen sheeted dough, comprising
flour; water in an amount of about 45% to about 70% by weight of the total amount of flour; a chemical leavening agent including at least one soda ingredient in an amount of about 0.5% to about 2% and at least one acid ingredient in an amount of about 0.5% to about 2% by weight of the total amount of flour; yeast in an amount of about 3% to about 9% by weight of the total amount of flour; salt in an amount of about 1% to about 3% by weight of the total amount of flour; a stabilizer in an amount of about 0.2% to about 0.5% by weight of the total amount of flour; sugar in an amount of about 3% to about 9% by weight of the total amount of flour; and vegetable shortening in an amount of about 1% to about 3% by weight of the total amount of flour;
wherein the frozen dough does not require proofing.

24. The frozen sheeted dough of claim 23, further comprising at least one ingredient selected from the group consisting of iron, glutathione, calcium sulfate, ascorbic acid, flavored oils, an enzyme, niacin, riboflavin, oil, L-cysteine, ammonium sulfate, corn meal, thiamine mononitrate, and at least one flavoring.

25. The frozen sheeted dough of claim 23, wherein the at least one soda ingredient of the chemical leavening agent is selected from the group consisting of sodium bicarbonate and potassium bicarbonate, and the at least one acid ingredient is selected from the group consisting of sodium aluminum phosphate, sodium acid pyrophosphate, and glucono delta lactone.

26. Frozen sheeted dough, comprising
high gluten flour; water in an amount of about 58% by weight of the total amount of flour; baking soda in an amount of about 1.5% by weight of the total amount of flour; sodium aluminum phosphate in an amount of about 1.5% by weight of the total amount of flour; yeast cream in an amount of about 6% by weight of the total amount of flour; salt in an amount of about 2% by weight of the total amount of flour; a stabilizer in an amount of about 0.33% by weight of the total amount of flour; sugar in an amount of about 6% by weight of the total amount of flour; vegetable shortening in an amount of about 2% by weight of the total amount of flour; ammonium sulfate in an amount of about 0.04% by weight of the total amount of flour; ascorbic acid in an amount of about 0.036% by weight of the total amount of flour; calcium sulfate in an amount of about 0.04% by weight of the total amount of flour;
wherein the frozen sheeted dough does not require proofing.

27. The frozen sheeted dough of claim 26, further comprising at least one ingredient selected from the group consisting of glutathione, oil, L-cysteine, corn meal, and at least one flavoring.

28. A method of making frozen sheeted dough, comprising
combining ingredients including flour, water, chemical leavening agent having at least one soda ingredient in an amount of about 0.5% to about 2% by weight of the total amount of flour and at least one acid ingredient, and yeast in an amount of about 3% to about 9% by weight of the total amount of flour;
mixing the ingredients for about 2 to about 4 minutes on a first speed and then for about 5 to about 7 minutes on a second speed that is faster than the first speed, wherein the mixing takes place at a temperature of about 58° to about 64° F.;
shaping the dough to form a shaped dough; and
freezing the shaped dough;
wherein the frozen sheeted dough does not require proofing.

29. The method of claim 28, wherein the yeast is present in an amount of about 4% to about 8% by weight of the total amount of flour.

30. The method of claim 28, wherein the yeast is present in an amount of about 6% by weight of the total amount of flour.

31. The method of claim 28, wherein the ratio by weight of yeast to the at least one soda ingredient is about 3:1 to about 5:1.

32. The method of claim 28, wherein the ratio by weight of yeast to the at least one soda ingredient is about 4:1.

33. The method of claim 28, wherein the yeast is in the form of yeast cream.

34. The method of claim 28, wherein the at least one soda ingredient is selected from the group consisting of sodium bicarbonate and potassium bicarbonate, and the at least one acid ingredient is selected from the group consisting of sodium aluminum phosphate, sodium acid pyrophosphate, and glucono delta lactone.

35. The method of claim 28, wherein the leavening agent is a slow acting leavening agent.

36. The method of claim 28, wherein the at least one soda ingredient is present in an amount of about 1.5% by weight of the total amount of flour.

37. The method of claim 28, wherein the flour is high gluten flour.

38. The method of claim 28, wherein the flour has preferably from about 10% to about 14% by weight protein.

39. The method of claim 28, wherein the ingredients further include one or more ingredients selected from the group consisting of iron, glutathione, calcium sulfate, salt, at least one stabilizer, ascorbic acid, flavored oils, an enzyme, sugar, niacin, at least one fat source, riboflavin, oil, L-cysteine, ammonium sulfate, corn meal, thiamine mononitrate, and at least one flavoring.

40. The method of claim 39, wherein the at least one stabilizer is a diacetyl tartaric acid ester of monoglycerides.

41. The method of claim 39, wherein the at least one fat source is vegetable shortening.

42. The method of claim 39, wherein the at least one flavoring is selected from the group consisting of oregano, basil, garlic, pepper, honey, sesame, cheese, cinnamon, wheat oats, peppers, onions, salsa based flavors, and tomatoes.

43. The method of claim 28, wherein the shaping comprises sheeting the dough to the form of a pizza.

44. The method of claim 43, wherein the shaping comprises sheeting the dough and cutting the dough with a rotary cutter.

45. The method of claim 28, wherein the shaping comprises sheeting the dough and shaping the dough into the form of breadsticks.

46. The method of claim 28, wherein the shaping comprises sheeting and perforating the dough.

47. The method of claim 28, wherein the shaping comprises cutting the dough with a splitter wheel.

48. The method of claim 28, further comprising topping the dough with at least one topping after the shaping.

49. The method of claim 48, wherein the at least one topping is selected from the group consisting of tomato sauce, pesto, cheese, pepperoni, sausage, ham, olives, mushrooms, peppers, pineapple, onions, tomatoes, and salt.

50. The method of claim 28, further comprising topping the dough with at least one flavoring after the shaping.

51. The method of claim 50, wherein the at least one flavoring is selected from the group consisting of oregano, basil, garlic, pepper, honey, sesame, cheese, cinnamon, wheat oats, peppers, onions, salsa based flavors, and tomatoes.

52. The method of claim 28, wherein mixing comprises mixing the ingredients for about 3 minutes on the first speed and about for about 6 minutes on the second speed.

53. A method of making frozen sheeted dough, comprising
combining at least the following ingredients
flour, water in an amount of about 45% to about 70% by weight of the total amount of flour, a chemical leavening agent having at least one soda ingredient in an amount of about 0.5% to about 2% by weight of the total amount of flour and at least one acid ingredient, yeast in an amount of about 3% to about 9% by weight of the total amount of flour, salt in an amount of about 1% to about 3% by weight of the total amount of flour, a stabilizer in an amount of about 0.2% to about 0.5% by weight of the total amount of flour, sugar in an amount of about 3% to about 9% by weight of the total amount of flour, and vegetable shortening in an amount of about 1% to about 3% by weight of the total amount of flour;
mixing the ingredients for about 2 to about 4 minutes at a first speed and then mixing for about 5 to about 7 minutes at a second speed that is higher than the first speed at a temperature of about 58° to about 64° F.;
shaping the dough to form a shaped dough; and
freezing the shaped dough;
wherein the frozen dough does not require proofing.

54. The method of claim 53, wherein the ingredients further include one or more ingredients selected from the group consisting of iron, glutathione, calcium sulfate, ascorbic acid, flavored oils, an enzyme, niacin, riboflavin, oil, L-cysteine, ammonium sulfate, corn meal, thiamine mononitrate, and at least one flavoring.

55. The method of claim 53, wherein the at least one soda ingredient is selected from the group consisting of sodium bicarbonate and potassium bicarbonate, and the at least one acid ingredient is selected from the group consisting of sodium aluminum phosphate, sodium acid pyrophosphate, and glucono delta lactone.

56. The method of claim 53, wherein the combining includes forming a pre-mix of chemical leavening agent, salt, stabilizer and sugar, and then combining the premix with flour, vegetable shortening, yeast and water.

57. The method of claim 53, wherein the ratio by weight of yeast to the at least one soda ingredient is from about 3:1 to about 5:1.

58. The method of claim 53, wherein the ratio by weight of yeast to the at least one soda ingredient is from about 4:1.

59. A method of making frozen sheeted dough, comprising
combining at least the following ingredients
high gluten flour, water in an amount of about 58% by weight of the total amount of flour, baking soda in an amount of about 1.5% by weight of the total amount of flour, sodium aluminum phosphate in an amount of about 1.5% by weight as compared to the amount of flour,
yeast cream in an amount of about 6% by weight of the total amount of flour, salt in an amount of about 2% by weight of the total amount of flour, a stabilizer in an amount of about 0.33% by weight of the total amount of flour, sugar in an amount of about 6% by weight of the total amount of flour, vegetable shortening in an amount of about 2% by weight of the total amount of
flour, ammonium sulfate in an amount of about 0.04% by weight of the total amount of flour, ascorbic acid in an amount of about 0.036% by weight of the total amount of flour, calcium sulfate in an amount of about 0.04% by weight of the total amount of flour,
mixing the ingredients for about 2 to about 4 minutes at a first speed and then mixing for about 5 to about 7 minutes at a higher speed at a temperature of about 58° to about 64° F.;
shaping the dough to form a shaped dough; and
freezing the shaped dough;
wherein the frozen sheeted dough does not require proofing.

60. The method of claim 59, wherein the ingredients further include one or more ingredients selected from the group consisting of glutathione, oil, L-cysteine, corn meal, and at least one flavoring.

61. The method of claim 59, wherein the combining includes forming a pre-mix of salt, sodium aluminum phosphate, baking soda, ammonium sulfate, ascorbic acid, stabilizer, calcium sulfate, Enriched Flour, and then combining the premix with high gluten flour, vegetable shortening, yeast cream and water.

62. Frozen pizza dough made by the method of claim 43.

63. Frozen breadstick dough made by the method of claim 45.

64. A method of making pizza, comprising
removing frozen sheeted dough according to claim 62 from a freezer and without proofing or thawing the dough, transferring the dough to an oven pre-heated to a temperature sufficient to bake the pizza and baking the dough.

65. The method of claim 64, further comprising adding at least one topping over the dough after removing the pizza dough from the freezer.

66. The method of claim 64, wherein the oven is a thermostatically-controlled oven.

67. A method of making breadsticks, comprising
removing frozen sheeted dough according to claim 62 from a freezer and without proofing or thawing the dough, transferring the dough to an oven pre-heated to a temperature sufficient to bake the breadsticks and baking the dough.

68. The method of claim 67, further comprising topping the dough with at least one topping after removing the frozen breadstick dough from the freezer.

69. The method of claim 67, wherein the oven is a thermostatically-controlled oven.
